(19) United States
(12) Patent Application Publication
(10) Pub. No.: US 2011/0079350 A1
(43) Pub. Date: Apr. 7, 2011

(54) LASER IRRADIATION SYSTEM AND LASER IRRADIATION METHOD

(75) Inventors: Kyong-Taeg LEE, Yongin-City (KR); Hyun-Cheul Shin, Yongin-City (KR); Won-Woong Jung, Yongin-City (KR)

(73) Assignee: Samsung Mobile Display Co., Ltd., Yongin-City (KR)

(21) Appl. No.: 12/894,288

(22) Filed: Sep. 30, 2010

(30) Foreign Application Priority Data
Oct. 5, 2009 (KR) 10-2009-0094383

(51) Int. Cl. B29C 65/16; G21G 5/00

(52) U.S. Cl. 156/272.8; 250/492.2; 156/380.9; 250/492.1

(57) ABSTRACT

A laser irradiation system includes a laser beam generator to generate laser beams, a laser beam irradiator to radiate the laser beams onto a target, a laser beam guide to detect whether one of the laser beams is reflected back toward the laser beam irradiator, a detector to convert the reflected laser beam into electrical signal data, and a controller to control the output of the laser beam generator, based on the signal data.

### CROSS-REFERENCE TO RELATED APPLICATION

This application claims priority to and the benefit of Korean Patent Application No. 10-2009-0094383 filed in the Korean Intellectual Property Office on Oct. 5, 2009, the disclosure which is incorporated herein, by reference.

### BACKGROUND

1. Field

The described technology relates generally to a laser irradiation system and a laser irradiation method.

2. Description of the Related Art

A laser irradiation system can be used for various purposes in the manufacture of display panels. In general, a display panel includes a pair of substrates that are bonded and sealed together with a sealant. A laser irradiation system is also used in a process of hardening a sealant, in order to bond and seal together a plurality of substrates constituting a display panel. That is, the laser irradiation system hardens the sealant, by radiating light onto the sealant, which is interposed between the substrates. However, there is a problem in that a laser beam is radiated not only on the sealant, but also on other areas of the display panel, thereby damaging the display panel. As such, a laser mask is disposed on the display panel, so that a laser beam is radiated only on the sealant, thereby preventing damage to the display panel.

However, since the laser mask is disposed between a laser irradiator and the display panel, the laser beam may be reflected by the laser mask back toward the laser irradiator. The reflection of the laser beam by the laser mask may occur, if the overall settings of the laser irradiation system are faulty. In this way, the laser beam reflected by the laser mask may damage the laser irradiator, thereby causing an enormous loss.

The above information disclosed in this Background section is only for enhancement of understanding of the background of the described technology, and therefore, it may contain information that does not constitute prior art.

### SUMMARY

An aspect provides a laser irradiation system that can prevent equipment from being damaged by a laser beam.

An aspect provides a laser irradiation method using the above laser irradiation system.

A laser irradiation system, in accordance with an exemplary embodiment, includes: a laser beam generator to generate laser beams; a laser beam irradiator to radiate the laser beams to a target; a laser beam guide to capture laser beams reflected back toward the laser beam irradiator; a detector to convert the captured laser beams into electrical signal data; and a controller to control the laser beam generator, based on the signal data provided by the detector.

According to some aspects, if the received signal data is greater than a preset numerical value, the controller may interrupt the output of the laser beam generator.

According to some aspects, the preset numerical value may represent a beam intensity sufficient damage the laser beam irradiator.

According to some aspects, the laser beam guide may be disposed adjacent to the laser beam irradiator.

According to some aspects, a plurality of optical fibers used as the laser beam irradiator, and one or more optical fibers used as the laser beam guide, may be formed in a bundle.

According to some aspects, the laser irradiation system may further include a table to support the target, and a laser mask disposed between the target and the laser beam irradiator and guide.

According to some aspects, the laser mask may have a blocking region and a transmitting region.

According to some aspects, the laser beam guide may sense a laser beam reflected from the blocking region of the laser mask.

According to some aspects, the laser irradiation system may further include a transfer unit to transfer the laser beam irradiator and the laser beam guide, relative to the laser beam mask.

According to some aspects, the target may be a display panel including a pair of substrates and a sealant bonding and sealing the substrates.

According to some aspects, the laser beam may harden the sealant.

A laser irradiation method, in accordance with an exemplary embodiment, includes: mounting a target on a table of a laser irradiation system including the table, a laser mask, a laser beam generator, a laser beam irradiator, and a laser beam guide; aligning the laser mask with the target; radiating laser beams generated by the laser beam generator to the target, through a transmitting region, using the laser beam irradiator; capturing laser beams reflected by the laser mask toward the laser beam irradiator, using the laser beam guide; interrupting the output of the laser beam generator, if the captured laser beams have an energy level of at least a preset energy level; and correcting any fault in the settings of the laser irradiation system, if the output of the laser beam generator is interrupted.

According to some aspects, the preset energy level may be an energy level is sufficient to damage the laser beam irradiator.

According to some aspects, the laser irradiation system may further include a detector and a controller, wherein the detector may convert the laser beam captured by the laser beam guide into electrical signal data, and the controller may control the output of the laser beam generator, based on the signal data provided by the detector.

According to some aspects, the laser mask may be divided into a blocking region and a transmitting region.

According to some aspects, the laser beam guide may capture the laser beam reflected by the blocking region of the laser mask.

According to some aspects, the target may include a pair of substrates and a sealant bonding and sealing the substrates together.

According to some aspects, the laser beam may harden the sealant.

In accordance with the exemplary embodiment, the laser irradiation system and the laser irradiation method can prevent equipment from being damaged, due to a reflected laser beam.

Additional aspects and/or advantages of the present disclosure will be set forth in part in the description which follows and, in part, will be obvious from the description, or may be learned by practice of the present teachings.

### BRIEF DESCRIPTION OF THE DRAWINGS

These and/or other aspects and advantages of the present disclosure will become apparent and more readily appreciated from the following description of the exemplary embodiments, taken in conjunction with the accompanying drawings, of which:

FIGS. 1 and 2 are block diagrams of a laser irradiation system, in accordance with one exemplary embodiment;

FIG. 3 is a cross-sectional view showing cross-sections of a laser irradiator and a laser detector of FIG. 1; and

FIG. 4 is a flowchart showing the sequence of steps of a laser irradiation method, in accordance with one exemplary embodiment.

### DETAILED DESCRIPTION

Hereinafter, exemplary embodiments of the present teachings will be described in detail, with reference to the accompanying drawings, such that those skilled in the art can easily carry out the present teachings. As those skilled in the art would realize, the described exemplary embodiments may be modified in various different ways, all without departing from the spirit or scope of the present invention. To clearly describe the exemplary embodiments, parts not related to the description are omitted, and like reference numerals designate like constituent elements throughout.

In the drawings, the sizes and thicknesses of the components are merely shown for convenience of explanation, and therefore, the present invention is not necessarily limited to the illustrations described and shown herein. In the drawings, thicknesses are enlarged to clearly express various layers and areas. In the drawings, the thicknesses of some layers and areas are exaggerated for convenience of explanation. It will be understood that when an element such as a layer, film, region, or substrate is referred to as being “on” another element, it can be directly on the other element or intervening elements may also be present.

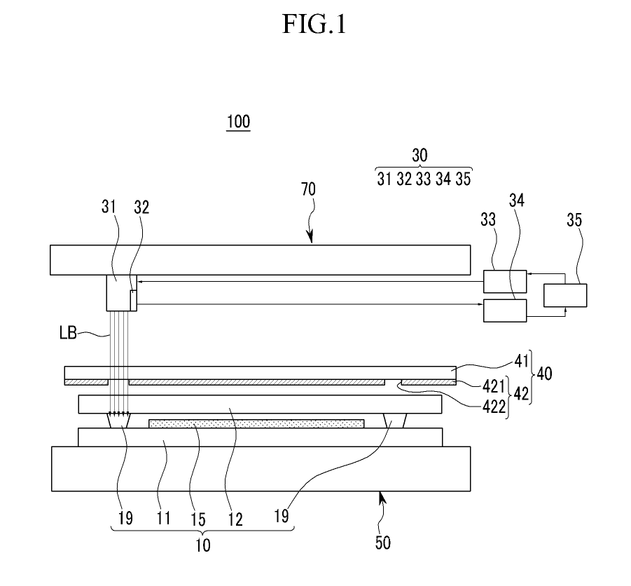

A laser irradiation system 100, in accordance with an exemplary embodiment, will be described with reference to FIGS. 1 to 3. As shown in FIG. 1, the laser irradiation system 100 includes a laser device 30, a table 50, a laser mask 40, and a transfer unit 70. The laser device 30 includes a laser beam generator 33, a laser beam irradiator 31, a laser beam guide 32, a detector 34, and a controller 35.

The table 50 supports a target 10 that is to receive a laser beam LB irradiated from the laser device 30. In the shown exemplary embodiment, the target is a display panel 10 including a pair of substrates 11 and 12 and a sealant 19 for bonding and sealing the pair of substrates 11 and 12. Moreover, in the shown exemplary embodiment, the display panel 10 includes an organic light emitting element 15, however, the present teachings are not limited thereto.

The laser beam generator 33 generates the laser beam LB. The laser beam irradiator 31 receives the laser beam LB generated from the laser beam generator 33 and radiates it to the display panel 10. For convenience of description, the laser beam LB is referred to as a single beam. However, it is understood that the laser beam LB can include a plurality of individual laser beams LB or be a single beam when generated from the laser beam generator 33. The laser beam irradiator 31 radiates the laser beam LB toward the sealant 19 of the display panel 10. Then, the sealant 19 of the display panel 10 is hardened by the laser beam LB. As shown, the laser beam LB when passing from the laser beam irradiator 31 has a plurality of beams LB, which can be portions of a single laser beam LB generated by the laser beam generator 33.

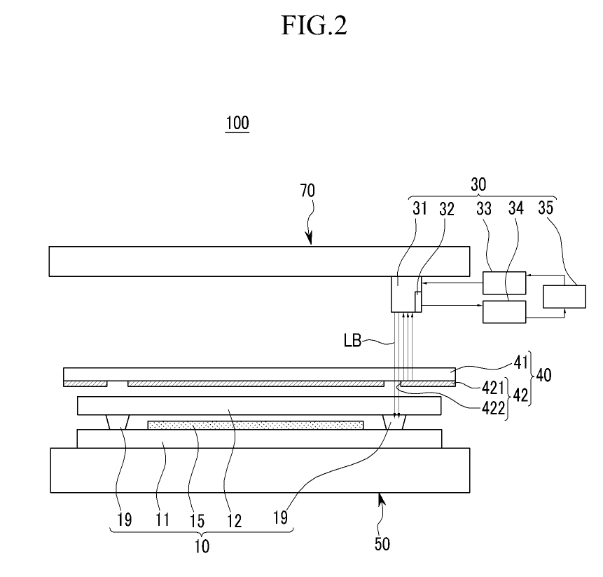

As shown in FIG. 2, the laser beam guide 32 captures a laser beam LB reflected back toward the laser irradiator 31, from among laser beams LB emitted from the laser beam irradiator 31. Concretely, if the overall settings of the laser irradiation system 100 are faulty, a laser beam LB emitted from the laser beam irradiator 31 can be reflected by the laser mask 40 and directed back toward the laser beam irradiator 31. The laser beam guide 32 then captures the reflected laser beam LB, and guides it to the laser beam detector 34. Moreover, the laser beam guide 32 is disposed adjacent to the laser beam irradiator 31, in order to effectively guide reflected laser beams reflected back to the laser beam irradiator 31.

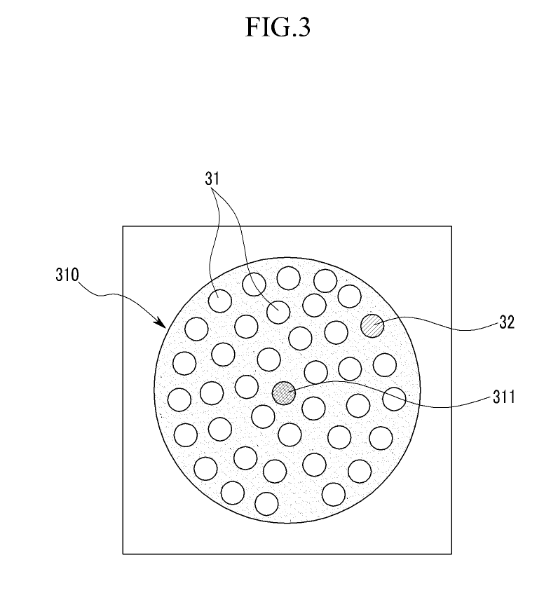

As shown in FIG. 3, the laser beam irradiator 31 is made of a plurality of optical fibers, and the laser beam guide 32 is made of one or more optical fibers. Concretely, the plurality of optical fibers used as the laser beam irradiator 31 and the one or more optical fibers used as the laser beam guide 32 are formed in a bundle 310. Moreover, an optical fiber 311 produces an aiming beam and is disposed at the center of the laser beam irradiator 31, in order to indicate an irradiation point of a laser beam LB. However, the laser bean irradiator 31 and the laser beam guide 32 are not limited to having the structure shown in FIG. 3, but and may have various structures, as would be apparent to one of skill in the art.

Referring again to FIG. 2, the detector 34 converts the laser beam LB captured by the laser beam guide 32 into electrical signal data. Further, the controller 35 controls the output of the laser beam generator 33, based on the signal data provided by the detector 34. While not required, the controller 35 can be a computer and/or one or more processors using software or firmware stored on a computer readable medium.

Concretely, if the received signal data is greater than a preset numerical value, the controller 35 interrupts the output of the laser beam generator 33. The preset numerical value relates to a beam intensity sufficient to damage the laser beam irradiator 31. That is, if the laser beam guide 32 captures a reflected laser beam LB that is strong enough to damage the laser beam irradiator 31, the controller 35 interrupts the output of the laser beam generator 33, to prevent damage to the laser beam irradiator 31.

The laser mask 40 is disposed between the laser beam irradiator 31 and the display panel 10, which is the target, and is divided into a blocking region 421 and a transmitting region 422. Concretely, the laser mask 40 includes a base substrate 41 and a mask pattern 42 formed on the base substrate 41. The mask pattern 42 is divided into the blocking region 421 and the transmitting region 422. The laser mask 40 allows the laser beam LB emitted from the laser beam irradiator 31 to irradiate only the sealant 19 of the display panel 10. That is, the laser mask 40 prevents the display panel 10 from being damaged, due to unnecessary irradiation.

As shown in FIG. 1, if the overall settings of the laser irradiation system 100 are acceptable, the laser beam LB irradiated from the laser beam irradiator 31 is radiated to the sealant 19, through the transmitting region 422 of the laser mask 40. As shown in FIG. 1, the entire laser beam LB passes through the transmitting region 422.

However, as shown in FIG. 2, if the overall settings of the laser irradiation system 100 are faulty, some or all of the laser beams LB radiated from the laser beam irradiator 31 irradiate the blocking region 421 of the laser mask 40. At this point, the light blocking region 421 of the laser mask 40 keeps the laser beams LB from unnecessarily irradiating portions other than the sealant 19, thereby preventing damage to the display panel 10. Although the light blocking region 421 of the laser mask 40 blocks the laser beam LB, it does not completely absorb the laser beam LB, but instead, reflects the laser beam LB. Then, the reflected laser beam LB is directed back toward the laser beam irradiator 31. In this way, as stated above, the reflected laser beam LB is captured by the laser beam guide 32. The controller 35 interrupts the output of the laser beam generator 33, according to the energy level of the laser beam LB captured by the laser beam guide 32, thereby preventing damage to the laser beam irradiator 31.

The transfer unit 70 transfers the laser beam irradiator 31, along with the laser beam guide 32, such that the laser beam irradiator 31 radiates the laser beam LB along the sealant 19 of the display panel 10. However, the present disclosure is not limited thereto. Thus, the transfer unit 70 may transfer both of the table 50 having the display panel 10 mounted thereon and the laser mask 40 together, in place of transferring the laser beam irradiator 31 and the laser beam guide 32.

With this configuration, the laser irradiation system 100 can prevent equipment, such as the laser beam irradiator 31, from being damaged, due to the reflected laser beams LB. Moreover, it is possible to prevent the display panel 10, which is the target, from being damaged due to erroneous irradiation by the laser beam LB. That is, it is possible to effectively and stably prevent the laser irradiation system 100 and the display panel 10 from being damaged during the manufacturing process.

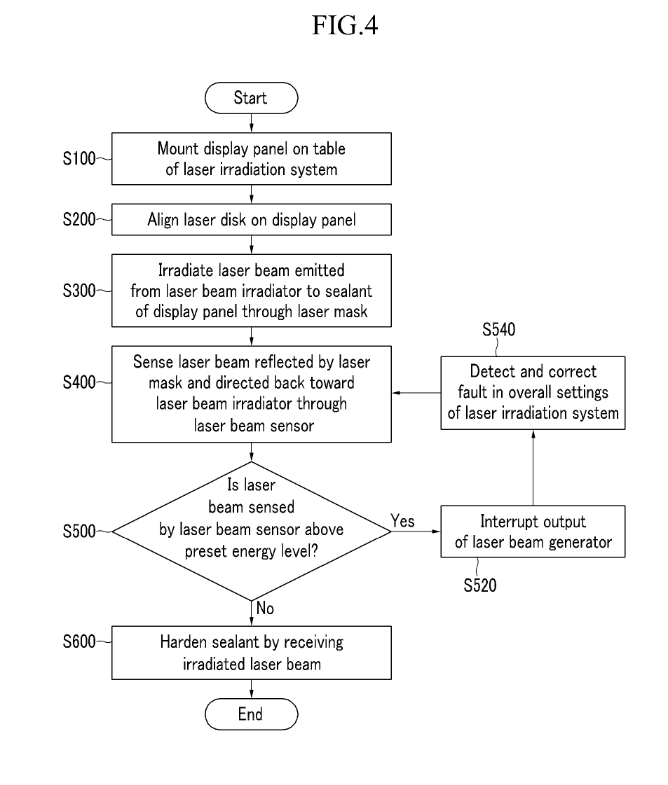

A laser irradiation method, in accordance with one exemplary embodiment, will be described with reference to FIGS. 1, 2, and 4. First, the display panel 10, which is a target, is mounted on the table 50 of the laser irradiation system 100 (S100). Then, the laser mask 40 is aligned on the display panel 10 (S200). At this point, the laser mask 40 is aligned such that the transmitting region 422 of the laser mask 40 and the sealant 19 of the display panel 10 overlap each other.

Next, the laser beam irradiator 31 radiates the laser beam LB generated by the laser beam generator 33 onto the sealant 19 of the display panel 10, through the transmitting region 422 of the laser mask 40 (S300). The laser beam guide 32 captures a laser beam LB reflected by the laser mask 40 toward to the laser beam irradiator 31 (S400).

Then, a detector 34 converts the laser beam LB captured by the laser beam guide 32 into electrical signal data, and the controller 35 determines whether the energy level of the laser beam LB captured by the laser beam guide 32 is greater than or equal to a preset value, based on the signal data received from the detector 34 (S500). If the reflected laser beam LB has less energy than the present energy level, the laser beam irradiator 31 continues to irradiate the sealant 19 of the display panel 10, thus hardening the sealant 19 (S600). However, if the reflected laser beam LB reaches or exceeds the preset energy level, the controller 35 interrupts the output of the laser beam generator 33 (S520). Here, the preset energy level refers to an energy level (beam intensity) that can result in damage the laser beam irradiator 31.

If the output of the laser beam generator 33 is interrupted, a fault in the overall settings of the laser irradiation system 100 is detected and corrected (S540). When the settings of the laser irradiation system 100 are modified, by eliminating the cause of a fault, a laser beam LB is then radiated through the laser beam irradiator 31, thus hardening the sealant 19 of the display panel 10 (S300).

As stated above, in accordance with one exemplary embodiment, the laser irradiation system 100 can prevent equipment, such as the laser beam irradiator 31, from being damaged due to the reflected laser beam LB. Moreover, it is possible to prevent the display panel 10, which is the target, from being damaged due to erroneous irradiation by the laser beam LB. That is, the laser irradiation system 100 and the display panel 10 can be effectively and stably protected from damage during the manufacturing process.

While this disclosure has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A laser irradiation system comprising:
a laser beam generator to generate laser beams;
a laser beam irradiator to radiate the laser beams onto a target;
a laser beam guide to capture at least one of the laser beams that are reflected back toward the laser beam irradiator;
a detector to convert the captured laser beam into electrical signal data; and
a controller to control the output of the laser beam generator, based on the signal data provided by the detector.

2. The laser irradiation system of claim 1, wherein when the received signal data is greater than a preset numerical value, the controller interrupts the output of the laser beam generator.

3. The laser irradiation system of claim 2, wherein the preset numerical value relates to a laser intensity sufficient to damage the laser beam irradiator.

4. The laser irradiation system of claim 1, wherein the laser beam guide is disposed adjacent to the laser beam irradiator.

5. The laser irradiation system of claim 4, wherein the laser beam irradiator and the laser beam guide comprise optical fibers grouped into a bundle.

6. The laser irradiation system of claim 1, further comprising:
a table to support the target; and
a laser mask disposed between the target and the laser beam irradiator and laser beam guide.

7. The laser irradiation system of claim 6, wherein the laser mask has a blocking region and a transmitting region.

8. The laser irradiation system of claim 7, wherein the laser beam guide captures the laser beams reflected from the blocking region of the laser mask.

9. The laser irradiation system of claim 6, further comprising a transfer unit to transfer the laser beam irradiator and the laser beam guide, relative to the table.

10. The laser irradiation system of claim 6, wherein the target is a display panel comprising a pair of substrates and a sealant bonding and sealing the substrates.

11. The laser irradiation system of claim 10, wherein the laser beams harden the sealant.

12. A laser irradiation method comprising:
mounting a target on a table of a laser irradiation system;
aligning a laser mask with the target;
irradiating the target with laser beams, through a transmitting region of the laser mask, using a laser beam generator and a laser beam irradiator;
detecting whether any of the laser beams is reflected from the laser mask toward the laser beam irradiator;
interrupting the output of the laser beam generator, if the reflected laser beam has at least a preset energy level; and
detecting and correcting a fault in the settings of the laser irradiation system, when the output of the laser beam generator is interrupted.

13. The laser irradiation method of claim 12, wherein the preset energy level is an energy level sufficient to damage the laser beam irradiator.

14. The laser irradiation method of claim 12, wherein:
the reflected laser beam is captured by guide, directed to the detector, and is then converted by a detector into electrical signal data; and
the signal data is output to a controller that controls output of the laser beam generator.

15. The laser irradiation method of claim 12, wherein the laser mask has a blocking region and a transmitting region.

16. The laser irradiation method of claim 15, wherein the reflected laser beam is reflected by the blocking region of the laser mask.

17. The laser irradiation method of claim 12, wherein the target is a display panel comprising a pair of substrates and a sealant bonding and sealing the substrates together.

18. The laser irradiation method of claim 17, wherein the laser beam hardens the sealant.

19. The laser irradiation system of claim 1, wherein the laser beam guide comprises an optical fiber to guide the reflected laser beams to the laser beam detector.

20. A laser irradiation method comprising:
irradiating a target with laser beams, through a laser mask, using a laser beam generator and a laser beam irradiator;
detecting whether any of the laser beams is reflected from the laser mask toward the laser beam irradiator;
interrupting the output of the laser beam generator, if the reflected laser beam has at least a preset energy level; and
detecting a fault in the relative position of the mask and the laser beam irradiator, when the output of the laser beam generator is interrupted.

21. A computer readable medium comprising software encoded with instructions to implement the method of claim 20 using one or more processors.
